(19) United States
(12) Patent Application Publication
(10) Pub. No.: US 2007/0016443 A1
(43) Pub. Date: Jan. 18, 2007

(54) Medication compliance systems, methods and devices with configurable and adaptable escalation engine

(75) Inventors: Joshua Seth Wachman, Chestnut Hill, MA (US); David Loring Rose, Cambridge, MA (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Vitality, Inc., Chestnut Hill, MA (US)

(21) Appl. No.: 11/480,859

(22) Filed: Jul. 6, 2006

Related U.S. Application Data
(60) Provisional application No. 60/698,792, filed on Jul. 13, 2005.

(51) Int. Cl. G06Q 10/00

(52) U.S. Cl. 705/2; 600/300

(57) ABSTRACT

A method and system of aiding medication compliance, where the patient has a specific compliance schedule for each medication, the method includes providing a feedback scheme for the medication; repeatedly monitoring the patient's compliance with the specific compliance schedule for that medication; providing feedback according to the feedback scheme and in response to said monitoring; modifying the feedback scheme based, at least in part, on the patient's compliance with the specific compliance schedule for that medication and the patient's response to feedback from the feedback scheme; and repeating the step of modifying, based, at least in part, on the patient's compliance with the then-current feedback scheme.

### RELATED APPLICATIONS

This application is related to and claims priority from co-pending U.S. Provisional Application No. 60/698,792, entitled “Medication Compliance platform with intelligent networked pillbox, escalation engine and data signaling feedback loops,” filed Jul. 13, 2005, the entire contents of which are hereby fully incorporated herein by reference.

### FIELD OF THE DISCLOSURE

This invention relates to medication compliance, and, more particularly, to systems, methods and devices supporting medication compliance.

### INTRODUCTION & BACKGROUND

Medication non-compliance is a major problem in healthcare.

Physicians prescribe medications for a large class of chronic, asymptomatic diseases. These medications must typically be taken daily for the rest of the patient's life in order to sustain quality of life and reduce health risks. Classic examples of diseases in this class include hypertension, hypercholesterolemia and osteoporosis. With many such diseases, a patient feels no different, whether or not they take their medication. So, unlike brushing one's teeth or even exercising, there are no apparent short to medium term costs for non-compliance. This presents a challenge even for those patients who want to comply, let alone those who need a helping hand.

Various attempts have been made in the past to try to increase and improve compliance by patients. Almost all of these systems are essentially reminder systems. For example, there are a large number of pillbox systems that marry alarm clocks to medication containers to remind patients when it is time to take their medication.

While various systems are described here, we do not admit that any of them qualify as prior art to our invention.

There are some compliance intervention systems offered by health care providers designed to remind the patient and alert a remote caregiver. These include a sensor/reminders in the home, a network connection (typically dial-up) to a backend server and outbound messaging/reporting to a caregiver or even back to the patient. These systems, however, are focused on reminding only and while they may include a remote non-professional caregiver in the reminder loop, forgetfulness is only part of the problem.

Other systems try to help patients manage complex medicine regimens. For example, the MD2 device by Interactive Medical Developments of Aurora Healthcare is a coffee maker sized device that stores and dispenses pills like a common gumball machine. The MD2 offers prerecorded audio messages to the patient and network connectivity back to a monitoring service. The MD2 is not designed to be portable, to be wirelessly connected to a network, to relay visual queues to another device resident in the home, or trigger escalating feedback to the patient. The focus on the MD2 is to arm disease management companies to assist patients on multiple medications and to help them effectively manage their regimen from home.

MedPartner of Honeywell Hommed is a platform that helps patients manage complex medicine regimes. The MedPartner platform accommodates several pill bottles and alerts the patient when pills in their regimen needs be taken. The MedPartner system uses RFID technology to label the bottle and its location in an egg-crate like base station. It is networked to a healthcare provider's monitoring station (say in home care or nursing home environments).

SimPill of South Africa describes a pill bottle employing a GSM transmitter which reports to a cellular network whenever a pill is taken. They advertise that their system includes a “pill bottle which, when opened, delivers an SMS [short message service] text message to a central server. The SMS contains a unique pillbox ID number as well as some information about the battery status of the pillbox. Each SMS is time stamped. The central server receives the incoming SMS and, if it is within the time tolerances set for the pillbox sending the message is simply stored for statistical purposes. Should no message be received within the time tolerances then the server can be set to produce a number of responses (e.g. sending a text message reminder to the patient's handset, sending a text message prompt to a family member or community based care giver, prompting them to visit the patient to ascertain the cause of non-compliance and provide assistance, sending a text message to a clinic based health professional or any other user determined response), or indeed escalate through these responses as time elapses with no incoming message in response to the previous outgoing message. Data on levels of compliance as measured by the device are stored for future analysis and use.” The SimPill device is ultimately another reminder system, based on its developer's theory (expounded on their website), that “[a]n important proportion of non-compliance is caused by the patient simply forgetting to take their medication.” When a patient does not take her medication, SimPill reminds the patient and then, possibly, a caregiver. Like the other reminder/alarm systems, SimPill ignores the more complex nature of non-compliance.

A category of medication compliance platforms has been developed specifically for the clinical trial market. In this market it is critically important to capture the dosing data of patients in order to measure their use and the medications efficacy during a clinical research trial. The price point of these devices necessarily is higher and they are built almost as a medical device to suit the stringent requirements of pharmaceutical manufacturers' clinical research requirements. For example, Informedix of Rockville, Maryland has a suite of products focused on compliance systems for the clinical trial market. Their Med-eMonitor is designed to be a clinical data capture diary and medication dispensing device in one. It has electronically monitored medication compartments and an instructional text screen. The device requires a cradle to upload the data and receive power. In the Med-eMonitor if the patient does not return the device to the base station there is no local or remote escalations to remind the patient to take their medication. The platform does not know if the device is even in the home. This suite of devices is designed for monolithic deployment—pharmaceutical companies deploy them in a research trial with a strict protocol that each subject patient must use to fulfill the requirements of the study.

AARDEX MEMS (Medication Event Monitoring System), a Swiss company, offers a smart cap to fit standard vials for clinical trial dose recording. This product employs inductive and capacitive wireless uploading technologies that require close proximity to a networked base-station in the patient's home to upload to a personal computer or even a remotely networked back-end database. The device includes an LCD (liquid crystal display). In order to upload the data from the monitoring caps, a patient has to place it on back into a specially designed base station.

There are conventional systems that track a patient's behavior in order to determine whether or not to issue an alert. When the patient's behavior changes, some sort of alert may be issued, e.g., to the patient's family or friends or the like. However, none of these systems adapt or modify the alert scheme based on the patient's behavior and/or based on the patient's response (or expected response) to a different alert scheme, they simply follow a set routine based on what the patient does (or does not do). The inventors have realized that repeatedly adapting and modifying an alert system, inasmuch as it affects compliance with a medication regimen, may change a patient's behavior.

Some prior systems, e.g., as shown in U.S. Pat. No. 6,771,174, require a local computer system at each patient's home to monitor the patient's drug taking. The computer can contact a pharmacist or emergency services if the patient deviates from his or her model behavior. Such systems impose heavy cost requirements—a dedicated computer—at each patient's home. In addition, such systems cannot take advantage of information about other patients, in particular, how other patients have responded to various alert schemes. The inventors were the first to realize that it is desirable and useful to apply techniques to a patient that have been learned from other patients.

The present invention improves on prior systems and overcomes their deficiencies.

### BRIEF DESCRIPTION OF THE DRAWINGS

The following description, given with respect to the attached drawings, may be better understood with reference to the non-limiting examples of the drawings, wherein:

FIG. 1 is an overview of a medication compliance system/framework;

FIG. 1B is a logical overview of the medication compliance framework;

FIGS. 2A-2C are exemplary medication containers;

FIGS. 2D-2M show various views of an exemplary pill cap;

FIG. 3A is a logical diagram showing exemplary internal details of a pill cap unit;

FIG. 3B is a logical diagram showing exemplary internal details of a feedback device;

FIG. 3C is a logical diagram showing exemplary internal details of a dongle unit;

FIG. 4 depicts an exemplary signaling scheme;

FIG. 5 depicts an exemplary escalation scheme;

FIG. 6A depicts a night-light embodiment of the feedback indicator/device;

FIGS. 6B-6F are schematic views of an exemplary night light feedback device; and

FIG. 7 is an example dongle.

### THE PRESENTLY PREFERRED EXEMPLARY EMBODIMENTS

Overview

Well-established behavioral medicine research shows that non-compliance with a medication regimen is fundamentally a behavioral psychology problem. The inventors have realized that timely intervention(s) by machine or human may influence the patient and should increase medication adherence rates.

There are several reasons why patients may not comply with their medication regimens. No one reason or set of reasons may apply to all people. People are motivated in different ways and by different things, and it is an unknown and possibly unique mix of factors that will motivate any particular individual to comply. The inventors have realized that any system for creating or supporting medication compliance will preferably be multi-faceted and be able to learn and adapt to each patient.

Commonly acknowledged reasons for non-compliance include the following:
Lack of doctor-patient accountability
Medication is too expensive
Lack of social support.
Patient's complain or perceive difficulty obtaining refills
Some patients think that they do not need the medication
Some patients do not know how to use the medication
Patients forget to take their medication
Patients complain of unpleasant side effects

The inventors have realized that a solution to the lack of compliance problem should deal with some or all of these factors.

System Architecture

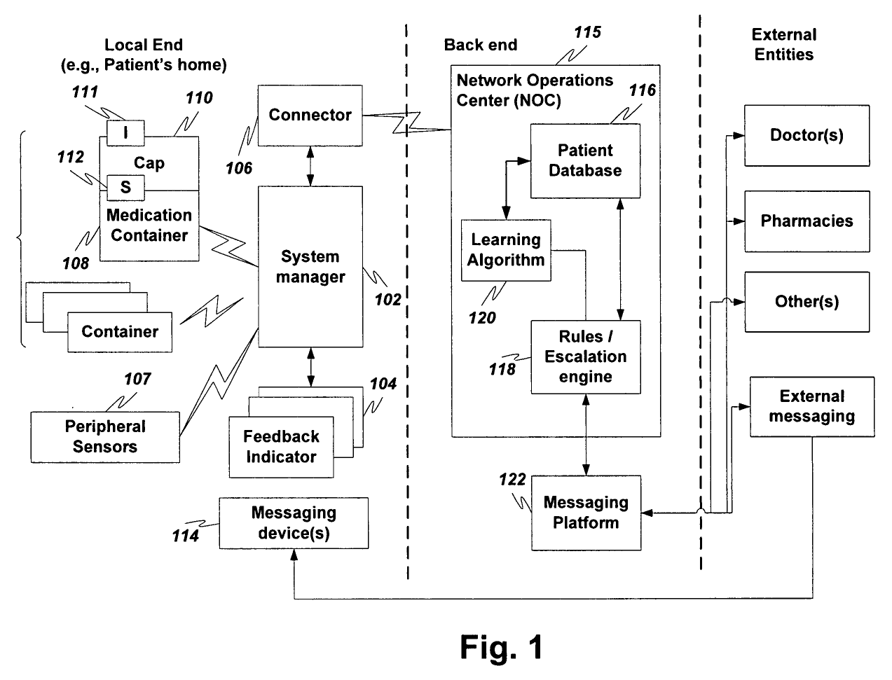

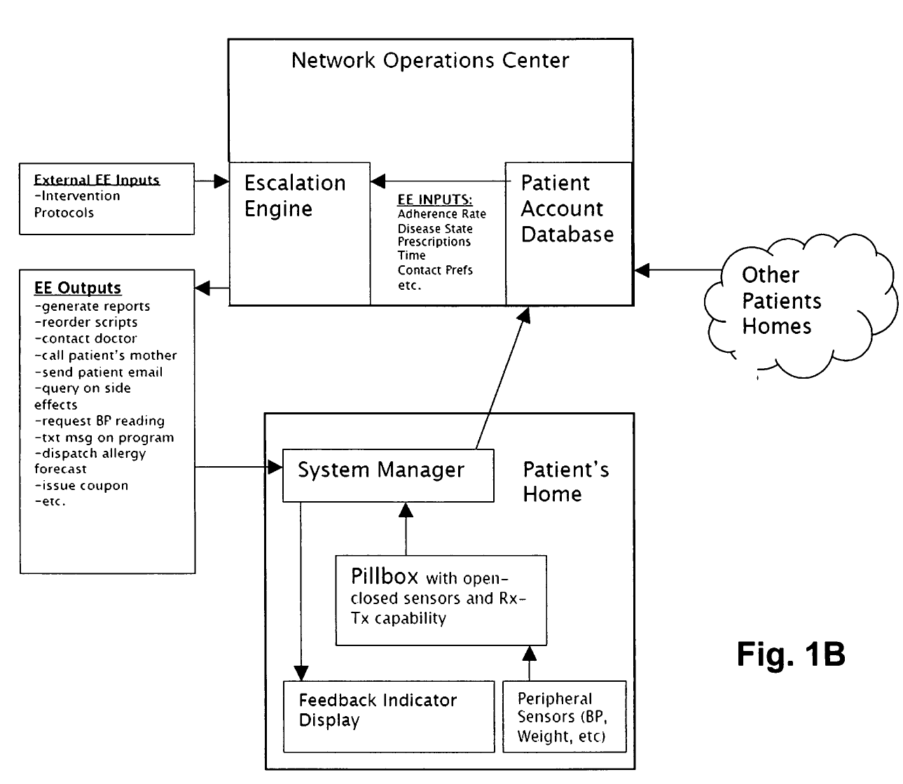

FIG. 1 shows an exemplary medication compliance system/framework 100, and FIG. 1B is a logical overview of the framework. For the purpose of this description, the users of the system whose compliance is being monitored and affected are referred to as patients. The use of the word “patient” or “patients” is not meant to limit the scope of the invention or to require any kind of doctor/patient relationship or any other kind of medical or legal relationship with the end users.

A compliance framework can be considered in three logical parts, namely the patients' homes (each a so-called “local end”), a back end, and a part corresponding to external entities that may be involved in the compliance system. Each of these parts is described here. The term “patient's home” is used herein to refer to the place (or places) at which a patient is expected to take his medication. It may include, e.g., the patient's home and/or place of work. The patient's home is sometimes referred to herein as the local end.

At a patient's home (or wherever they are supposed to take their medication), the patient is provided with a local system which includes a system manager 102, at least one feedback indicator 104 and a connector 106. The connector 106 allows the local end to connect with the rest of the system (described below), and may be a modem, a network connection and the like. Some or all of these components may be integrated into a single device. For example, the system manager 102, a feedback indicator 104, and the connector 106 may be co-located and/or provided in a single device. Alternatively, e.g., the system manager 102 and connector may be formed in a single device. If there is more than one feedback indicator, the system manager may be incorporated into one of them.

The patient's medication is provided in a container 108 with a cap 110. The container 108 may be a regular container or may be specifically adapted to operate with the cap 110. The container/cap combination may be in the form of pill cap, a multi-compartment pillbox, a salve-tube cap, a syringe, an inhaler, a pump dispenser, a drop dispenser and the like. Those of skill in the art will understand, upon reading this description, that the container/ cap combination can be used with any medication delivery system and with any type of medication, regardless of its form or dosage. The cap 110 may be fully or partially removable or fully or partially openable, or it may be an integral part of the container through which medication is dispensed.

Those of skill in the art will realize, upon reading this description, that the container/cap combination may take any form, as long as the system can detect when medication was likely or possibly dispensed.

Although only one medication container is shown in detail in FIG. 1 (for the purposes of this description), it will be understood and appreciated that a patient may have a number of such containers for different medications. Additionally, a particular home (or location) may have medication containers for more than one patient. Thus, a particular patient may have more than one container (as shown in FIG. 1), each of which may have a cap and sensors as described above. Those skilled in the art will realize and understand, upon reading this description, that the number and type of containers will depend on the various medications that the particular patient is supposed to take, and that the containers need not all be the same size or type. E.g., some may contain pills; others may contain drops, and so on.

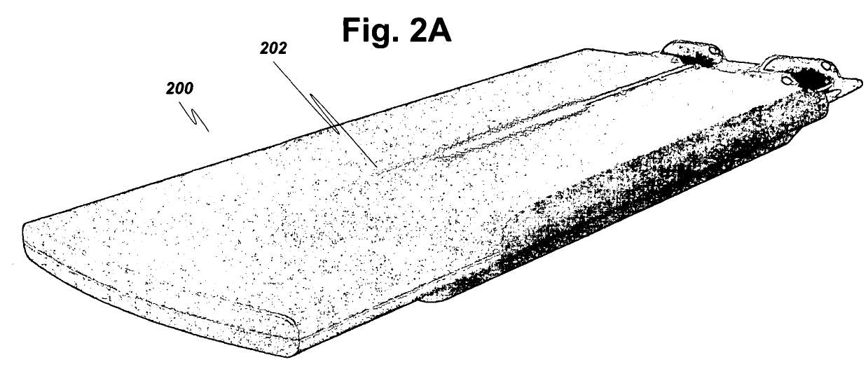

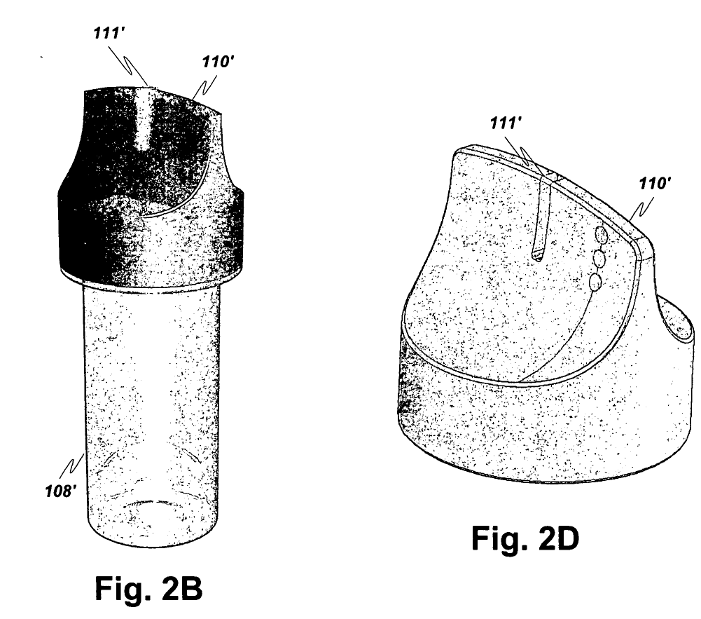

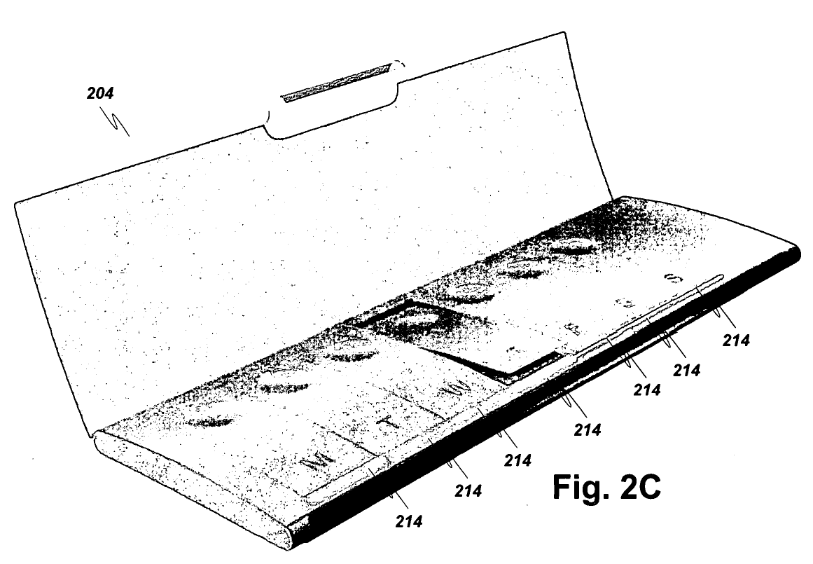

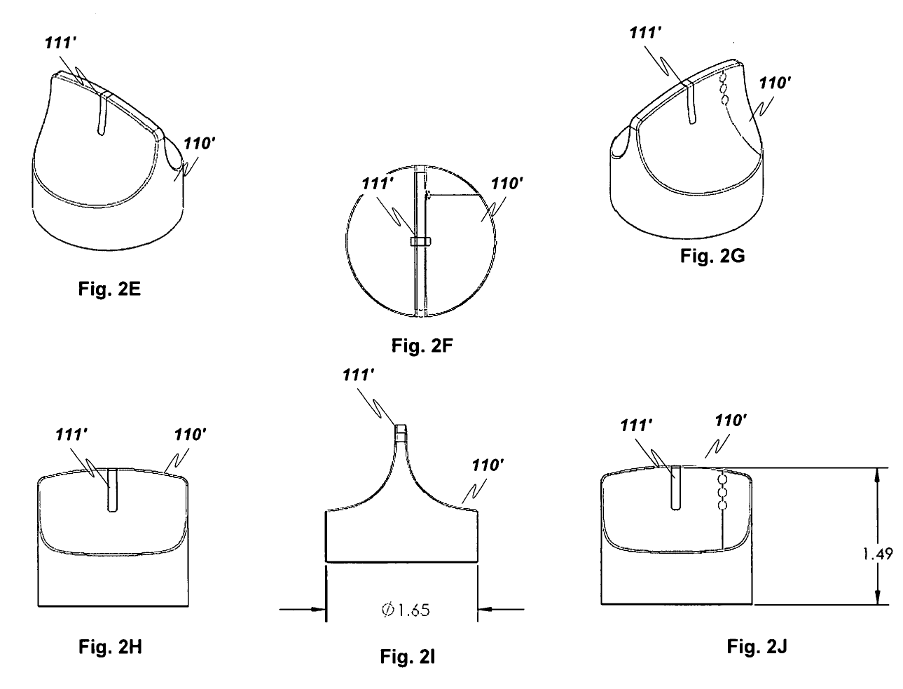

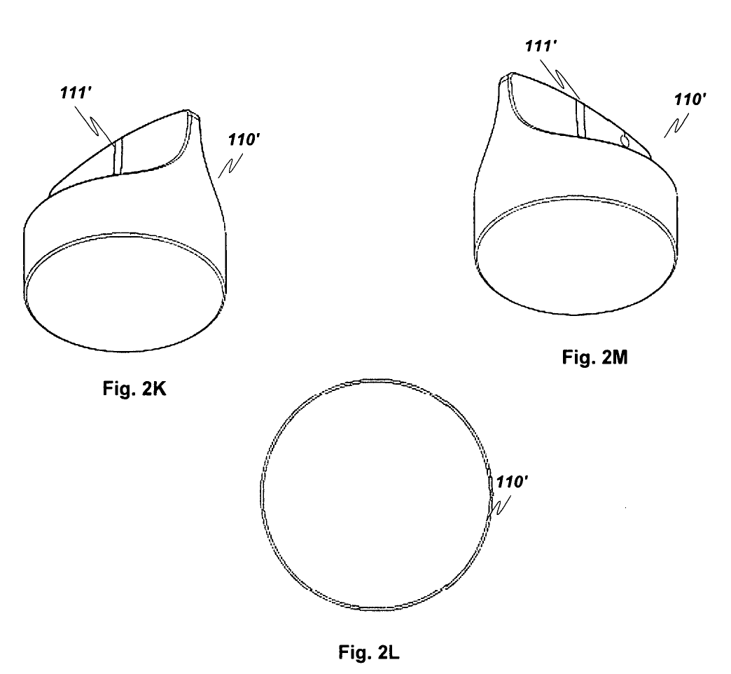

FIGS. 2A-2C shows examples of container/cap combinations. FIG. 2A shows a sleeve 200 with LED(s) 202 that may be used, e.g., for initial or sample doses or for packs. FIG. 2B shows exemplary pill container 108′, and FIG. 2C shows an exemplary multi-compartment pillbox 204 with a multicolored LED 214 associated with each compartment and display screen (e.g., e-ink or LCD).

As used herein, the term “medication” refers to any kind of medicine, prescription or otherwise. Further, the term “medication” includes medicine in any form, including, without limitation pills, salves, creams, powders, ointments, capsules, injectable medications, drops, vitamins and suppositories. The scope of this invention is not limited by the type, form or dosage of the medication.

At least one sensor 112 is embedded into the medication container 108 and/or the cap 110. The sensor 112 is triggered whenever the container is opened and closed. The sensor may be a pressure sensor, a piezoelectronic sensor, a light sensor, a motion sensor or the like. If more than one sensor is used, the sensors need not all be of the same kind. The function of the sensor(s) is to detect that the medication container has been opened (and then closed). Any sensor(s) (alone or in combination) that achieve this function are acceptable.

In some embodiments, the sensor also detects that the correct medication dose was actually removed from the container.

The system assumes that if the medicine container has been opened and then closed, that the medication was actually taken and that the dosage was correct.

A patient may also have one or more external messaging devices 114. Examples of such devices are a telephone (wired or wireless), a pager, a computer (with instant messaging or e-mail), a facsimile machine and the like. Such devices should be able to receive messages from an external source and provide those messages, in whatever form, to the patient.

A local end may also include one or more peripheral sensors 107 to measure and provide data such as the patient's weight, blood pressure (BP), pulse, etc. Peripheral measurements can be provided automatically to the system manager 102 and, in some cases, may be requested by the system manager.

The various containers, sensors and feedback indicators may communicate with the system manager 102 in any known way. The presently preferred implementation uses radio frequencies similar to that used in domestic garage door openers or key fob key-less entry systems. Other protocols such as Bluetooth or 802.11 may be used.

The system manager 102 receives information from and about the sensors in its jurisdiction—the patient's home. The system manager 102 also communicates with the back end (described below), e.g., via connector 106 using, e.g., a network. In preferred embodiments, the connector 106 is a dedicated telephone dialup modem called a network gateway.

A network gateway is a device that connects the system manager 102 to an external network via POTS (Plain Old Telephone Service) line modem, cellular, pager, 802.11 connections, or the like. In the POTS line modem version, the connector device may be embedded into a so-called “dongle”. In addition to the network connectivity, the dongle may communicate with the system manager over wireless, radio frequency communications.

The suite of devices described above communicates locally (in the home) and asynchronously from the virtual “backend” system components. Schematically these are local devices that communicate with the backend.

The backend is a data service platform that manages individual patients' data. The backend includes, integrated into a Network Operations Center (NOC) 115, a patient database 116, a rules and escalation engine 118, learning engine 120, and a mechanism 122 for outbound messaging in various communication modes (e.g., SMS, phone, Interactive Voice Response (IVR), print, email, facsimile, etc).

The database 116 stores information relating to some or all of: the patient account information, preferences, contact information, medication and disease state data, compliance history and response profiles (behavior changes as a function of interventions made). The database 116 obtains data from patient homes and provides input to the escalation engine 118.

The rules/escalation engine 118 accounts for the appropriate schedule of interventions, timing, contacts, messaging content, etc. These include patient-specific preferences (e.g., if after 9 a.m., call patient at their work number) and programmatic specific decision rules (e.g., given the patient's behavioral assessment, call on this frequency with this set of messages, etc) or medication/disease state specific rules (e.g., if not taken within X days escalate to the top level of urgency).

The escalation engine essentially controls a set of actions that need be taken in a certain order, based on various inputs from the patient database as well as possible external inputs. For example, the patient database 116 may provide the escalation engine 118 with information about a particular patients adherence rate, disease state, prescriptions, time, contact preferences, etc. It should be understood that the desired outcome is not always to simply take the medication; it could be to receive education, refill a script, converse with a counselor or some other act or acts. The next stage in the escalation appropriate for a particular patient is generally governed by their stage of readiness to change their behavior accordingly.

The order of actions determined by the escalation engine 118 is sorted base on the urgency of desired patient behavior and appropriateness of the next stage of behavior change as determined, e.g., by various means including independent clinical research using control and intervention groups, experience with other patients using the protocol and historical experience with the subject patient among other means. This can be virtually represented as a decision tree where each leaf has an action, a probability of outcome and a child-parent relationship. How the tree is traversed is governed by the inputs from the local devices and the results of historical outputs fed back.

The learning engine 120 implements a process or algorithm (preferably implemented in software) in which a relationship between a set of inputs and outputs can be optimally defined. The learning algorithm's goal is to optimize the adherence behavior of the individual patient against a set of options. Analysis of all patient data may help seed statistical probabilities of certain patient events and set performance benchmarks. The learning engine provides an evaluation of where things are in an escalation and all the patient situations information including the historical learning from past encounters with the patient and other patients like the subject patient.

The messaging platform 124 is the outbound communication gateway for the backend, and it enables various ways to get information back to the patient for feedback on their compliance behavior. This could be accomplished via phone, facsimile, email, SMS, and the like, using one or more external entities such as, e.g., a telephone company.

Research in behavioral change informs us that making rewards intermittent and of varying magnitudes may be used as an effective approach to motivate behavior. E.g., as with a lottery, the hope and expectation of reward keeps people playing. This lesson in behavioral psychology is applicable to aspects of the present system.

Accordingly, in some embodiments, a random component is introduced to the escalation engine to enable feedback for compliance to be delivered with varying magnitude of response and with intermittent certainty. For rewarding good behavior an approach which metes out acknowledgment creates the expectation with the patient that their ongoing compliance has a causal relationship with their receipt of a reward, where in fact the present system creates the opportunity to receive a reward and the magnitude of the reward varies. This approach avoids patient fatigue to the positive feedback. Similarly, if an escalation is warranted for any event (or missed event), it may not always be sent in the same mode (email, SMS, etc). This approach avoids patients becoming desensitized to automatic and/or rote signaling (e.g., automatic or rote messaging, beeping, buzzing, ringing, calling, emailing, etc.). Rote signaling may desensitize the patient to the message's arrival if not the content or intent of the message itself. To be more effective, embodiments of the present system may randomize the delivery mode of communication, the content of the message and even the frequency of messaging. This is consistent with the change protocol, learning component and escalation engine but introduces a differentiator in the approach which supports the behavioral change objective of the present platform.

Those skilled in the art will realize and understand, upon reading this description, that such a randomizing component may be implemented as a subsystem of the rules engine as it is influenced by the learning algorithm and must feedback into the patient database but also affects the messaging platform output.

Various preferred embodiments or implementations of local devices are now provided.

In a preferred embodiment, the container is a pill container and the sensor is in a pill cap.

Pill Cap

FIGS. 2D-2M show various views of an exemplary pill cap 110′, with light-emitting diode (LED) 111′ (e.g., a tri-color LED). FIGS. 2E-2M are schematic diagrams of the example cap. The dimensions shown in FIGS. 21-2J are given by way of example only, and those skilled in the art will realize and understand, upon reading this description, that different and/or other dimensions may be used, although it is preferably that the diameter of the cap conforms to standard pill bottles. The connector system (for connecting the caps to bottles) is not shown. Those skilled in the art will realize and understand, upon reading this description, that the actual mechanical interlock mechanism (e.g., screw, bayonet mount, snap-on, etc.) used with each cap will depend on the size and kind of bottle as well as the bottle's interlock system. In some embodiments, an adaptor may be provided to allow caps for one kind of bottle to fit on another kind of bottle.

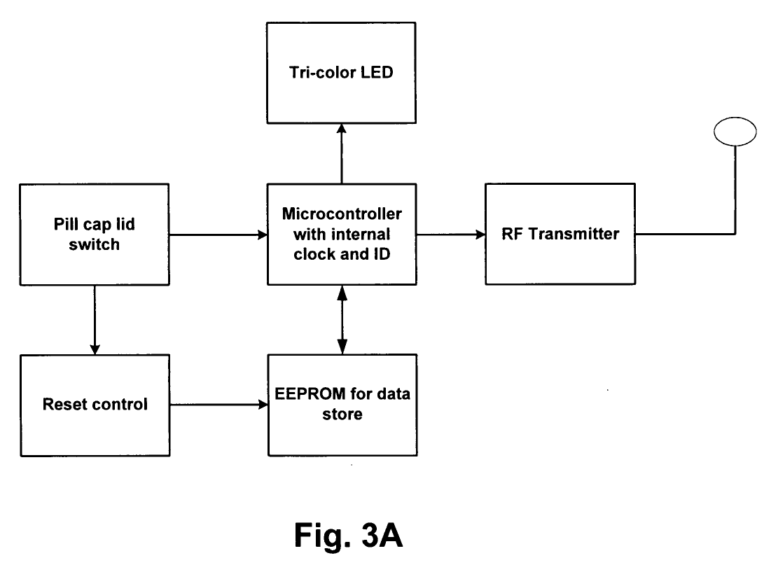

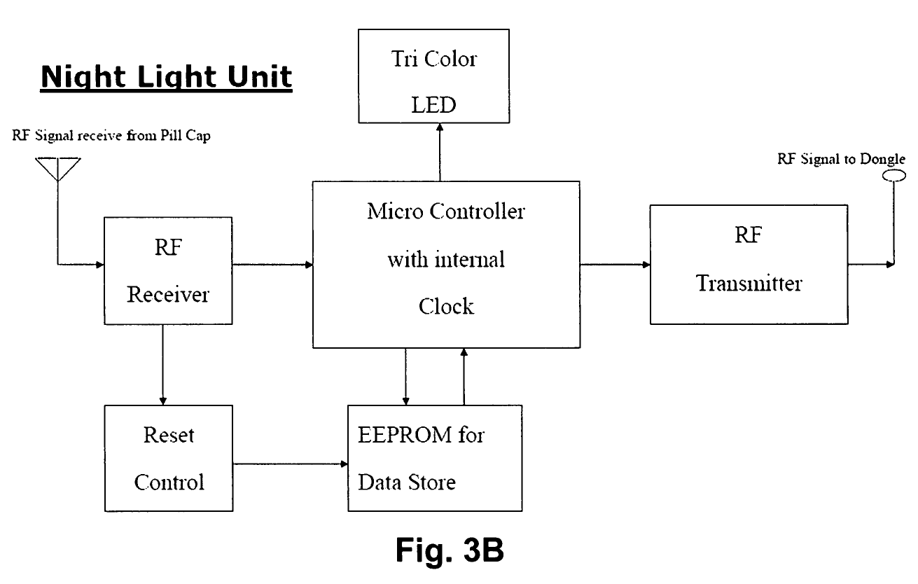

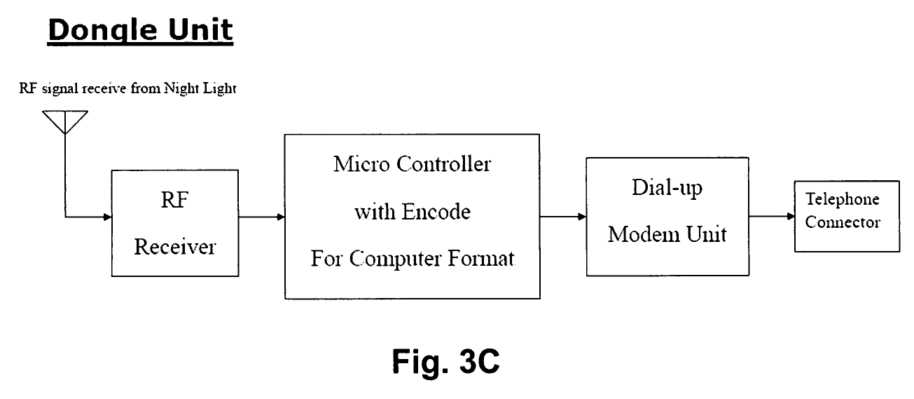

With reference to the diagram in FIG. 3A, in a presently preferred implementation, the pill cap includes an RF (radio frequency) transmitter, data store (e.g., EEPROM memory), a battery, a clock, some illumination mechanism (e.g., a tri-color LED), computational resource (computer) and appropriate circuitry which ties these components together to enable the functional behavior to take place as described below.

A one-way pill cap only contains an RF transmitter. It broadcasts a signal whenever it is opened and then closed within some period of time. Optionally this transmit signal may also be bundled with a payload of data which includes, battery level and a history of last dosing event (e.g., valid close times, where valid is defined to be the time between open and close is short and known) times, unique identification, etc.

A two-way pill cap (includes a transmitter and a receiver) transmits a signal whenever it is opened and closed as above. However this configuration also enables the cap to receive information from another device downstream which can, e.g., (a) update the cap it with new dosing regimen (revised schedule); and/or (b) check if the cap is in range. The two-way pill cap is the preferred version, but it does require more software management (overhead) and power.

Those skilled in the art will realize, upon reading this description, that different and/or other data may be provided to a one-way cap and to and from a two-way cap.

In a preferred embodiment the pill cap includes a light sensor that can detect changes in ambient illumination. This is part of a further battery saving scheme that enables the illuminator to turn off if the container is stored in a dark place. Patients often store their medication in a closed cabinet or drawer (much medication should be stored in a dark place) and there is no reason to deplete battery illuminating the feedback signal if no one can see it. In this scenario the pill cap immediately gives visual indication that it is dose time (“its me” (as opposed to the other caps for which it is not time to dose now)) if dose time has occurred and the ambient light sensor has indicated a change (suggesting it is in view of patient). The ambient light sensor could be replaced with or supplemented with a motion sensor.

Pillbox

The sensor 112 in the pillbox may be any kind of sensor (including, without limitation, e.g., electromechanical switch, electromagnetic switch, optical sensor, motion sensor, mechanical change, inductive coupling, weight change sensor, etc.) that can be appropriately triggered—i.e., whenever the container 108 is opened. In the simplest case of a pillbox, it has a top which, when moved or removed or when removed and replaced, triggers the activation sensor. This action causes the transmission of a signal from the pillbox 108 to the system manager component 102. The system manager may be across the room or across the country. In the latter case, the wireless transmission would leverage existing and pervasive long-range wireless or landline networks or local phone line service via a network interconnect that relays the signal to a remote caregiver's home. In the preferred embodiment the system manager 102 is in the same facility as the pill cap 110 and may trigger an audio or visual feedback queue on another device (e.g., on feedback indicator 104). The cap 110 preferably includes a feedback device 111, e.g., a light-emitting diode (LED), ambient light device, or the like.

The pillbox is preferably powered by battery (or dedicated power line) sufficient to periodically transmit a system healthy, sensor switch triggered (open-close), and unique box identification, time and date stamp signal. In a simple implementation, the box may also have means to receive a network healthy, in range or other data signal from the system manager.

In addition, the pillbox may include some or all of the following optional features:
a visual, auditory or vibratory cues which indicate the state of compliance against a schedule as measured against a prescribed regimen. If the queue is visual it could color average over time;
compartments or sub-compartments each with its own sensor;
the pillbox may physically and logically connect to another box and when joined together may share the unique identification number, RF transmission or externally signaled transmissions/receptions;
a text or graphical screen or other standard display means to deliver networked messages, dosing reminders, news information, appropriately timed interventions, alerts of pharmacy reorder ready signals, etc.;
a set of buttons which can enable the pillbox user to respond to multiple-choice questions, these buttons may be integrated into a touch screen.

In the preferred embodiment the pillbox is used for storing pill formulated medicine. The pillbox may have several compartments each of which locates a particular dose or organizes a particular day's worth of pills. The pillbox is manually loaded or may receive a cartridge of prepackaged pills configured with dose or daily compartments that interlock with the interior proportions of the pillbox.

Each box compartment has a lid which can sense when it has been opened and can cause a signal to be generated corresponding to the time and date of its opening and closing.

Each compartment may optionally have an electronic weight sensor beneath it that enables a signal corresponding to the time, date and weight of something being added or removed to be generated (microgram scale). The weight sensor need only take a measurement when the lid switch is opened and closed within a prescribed time window. During a system setup step the pillbox can be given the data as to what total weight it should expect in each compartment and the corresponding weights of each pill therein. In this way the box can sense and report whether a pill has been removed and with varying levels of precision (e.g., as a function of the pill weights, scale's sensitivity and constellation of pills in the compartment and pre-programmed knowledge) determine which pill was removed from which compartment. The removal of a pill from a pillbox compartment shall be called a dose.

If the pillbox receives an optional preloaded cartridge, its placement into the box (receiver) supersedes manual pill-by-pill loading. The lid and weight scale still function as described above. This feature contemplates a pairing of blister packed medication and a pillbox designed to marry with that form factor.

Each compartment may have any of a number of other types of sensors that can identify the box contents. This could include an RFID reader, a laser scanner, an image sensor or a radiating densitometer.

In the case of the RFID (radio frequency identification) reader, the compartment and pillbox can sense which pills are inside by pulsing the RFID encoded pills and reading the response. In the case of a pill with a holographically encoded coating a laser scanner can read the pill's unique identifiers. In the case of an image sensor the pillbox can sense reflected light from within the box from a source that is emitted from an embedded lamp. In this case an image array that represents the box contents may be created. Using known means the image array can be uploaded via the transmitter and ultimately a network connection and then analyzed remotely by known means using computational resources greater than those anticipated may be embedded in the sensor device. This technique can count and identify which pills are homed within each compartment and be used as a verification step to ensure the number and type of pills in each compartment are accounted for. In the case of a radiating densitometer, the sensor can collect the density of radiation and discern how many and what shape pills are inside.

The pillbox may be electrically powered by battery, rechargeable battery or connection to the electricity grid. The device will preferably have permanent and temporary (flash) memory.

The device offers the patient feedback with a set of local displays. In the simplest form, the device will have a set of lights and noise-making apparatus but these could also be remote to the device.

Each signal corresponds to a particular dose time and will follow an escalation should doses not be removed during a specified window of time. The duration of each window may be programmed dynamically as a function of past dosing behavior with the subject patient and others deemed similar, and the urgency of taking the particular medication.

Escalations on the box are initially calm and polite. They may become increasingly persistent, if not intrusive, should a dose not be taken according to the regimen. Presenting the alerts in a manner which starts as subtle, escalating to insistent, is important because research indicates insistent alerts are perceived to be annoying and patients tune them out.

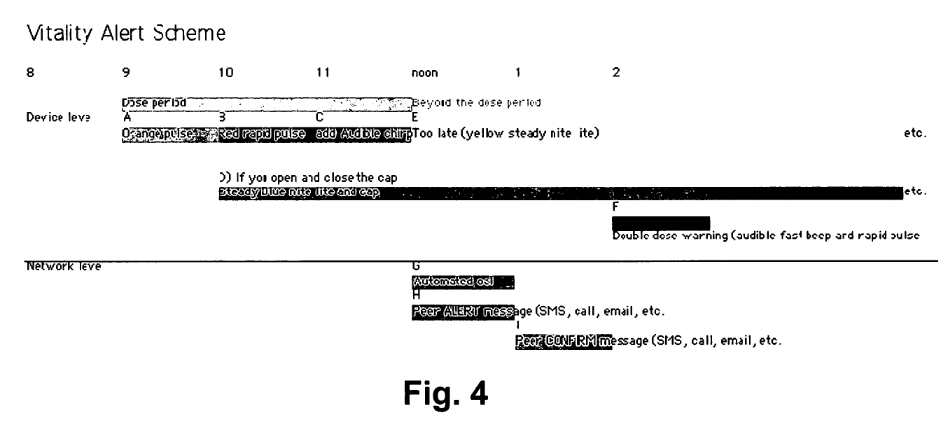

A signaling scheme such as the example shown in FIG. 4 may be used to indicate to the non-compliant patient that it is time to take their medication. This diagram illustrates how the device level and Network Level are synchronized but physically independent. With reference to FIG. 4, there is a dose period during which the patient needs to take the medication. After the dose period has ended, the patient should not take the medication and should wait until the start of the next dose period. The length of the dose period and of the wait period between doses is therapy specific. There are three signal states during the dose period. The first two are visual (A, B), and the third is audible (C). At any time, if a pill cap is opened and then closed, the devices reflect that through a glowing blue (D) cue.

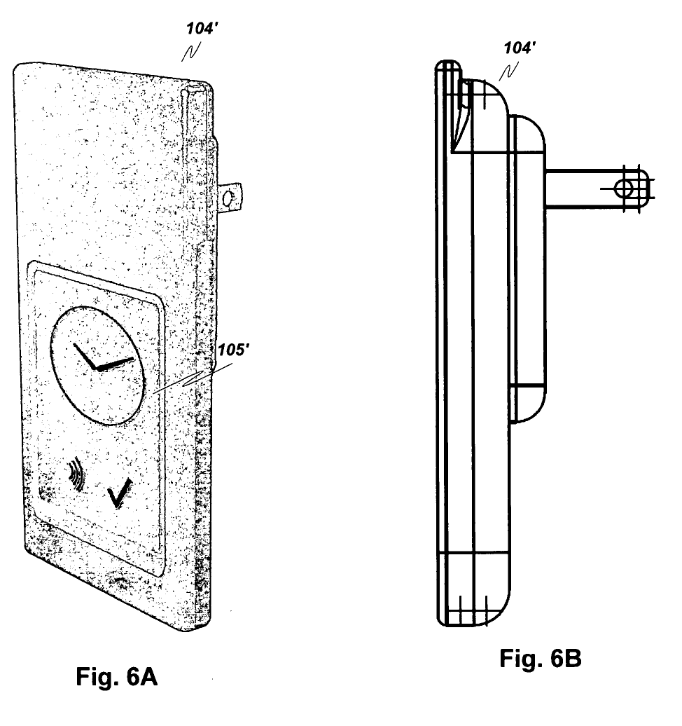

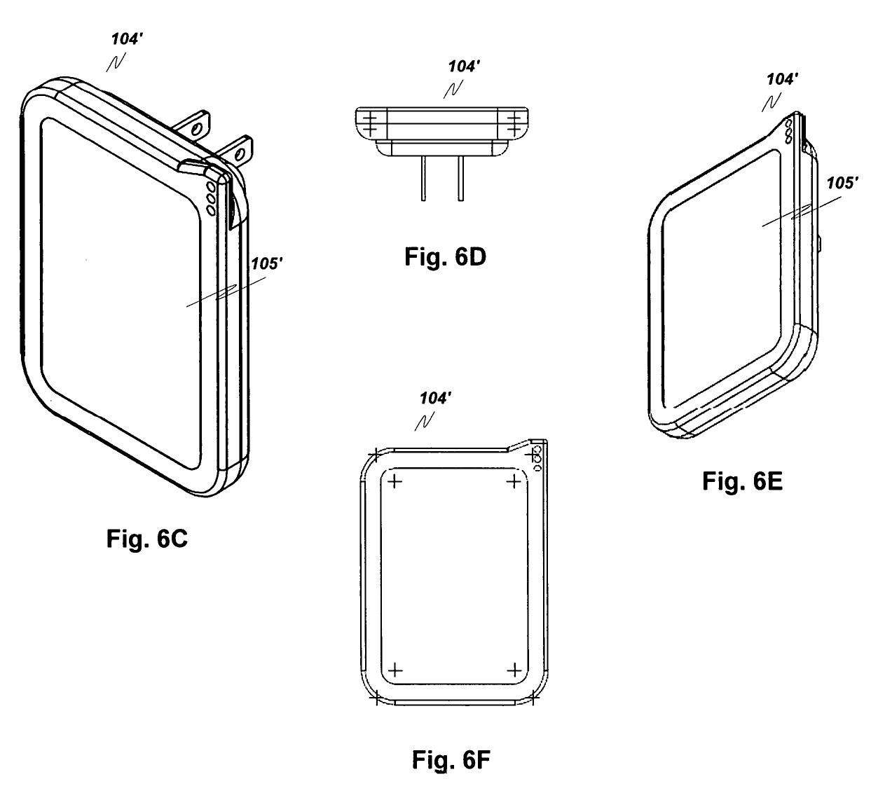

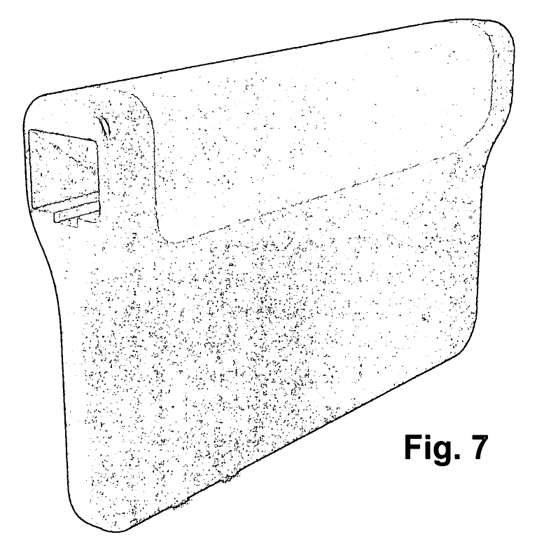

Used in conjunction with a night-light feedback/notification device (e.g., as shown in FIG. 6), the above example may operate as shown in the following table:

| State | Description | Action |
|---|---|---|
| A | “Take Your Pill Orange | Cap pulses amber/orange until |
| | Window” | escalation. Night-light does the same. |
| B | “Red Window” | Cap pulses red every 1 second until. |
| | | Night-light does the same. |
| C | Chirp Window | In addition to pulsing red, cap chirps |
| | | every minute, with escalating volume |
| | | until Dose Period Ends. Night-light |
| | | does the same. The chirps on the night- |
| | | light and cap alternate for 5 seconds on |
| | | each. |
| D | Pill Taken Blue State | Cap turns blue and stays blue for 30 |
| | | seconds and then goes dark until next |
| | | event. If before next event, light sensor |
| | | detects ambient illumination change, |
| | | then cap turns blue for 30 seconds. This |
| | | reminds patient they have already |
| | | dosed. Night-light turns blue and stays |
| | | blue until next dosing time. |
| E | Double dose warning | 1) Cap beeps audibly 3 times a second |
| | (open cap, not closed) | for 5 seconds then |
| | | 2) Night-light chirps audibly 3 times a |
| | | second for 5 seconds |
| | | 3) This oscillates back and forth until |
| | | cap is replaced |
| F | Too late period | If medication has not been taken during |
| | | the Dose Period then night light glows |
| | | yellow. If pill cap senses ambient |
| | | illumination change, it glows yellow for |
| | | 30 seconds. If during the “Too Late |
| | | Period” a cap open/close is detected. |
| | | Then “Pill Taken Blue State.” |

Those skilled in the art will immediately realize, upon reading this description, that the above windows and actions are merely exemplary, and that different and/or other actions may be performed.

Thus is described a two-stage escalation system. The basic series of alerts occur on the local devices. This may cascade to a remote series of alerts if the local fail to achieve dosing compliance. A benefit of this approach is that the local system does not need be connected full time to the network.

The remote escalations can be evaluated with the benefit of a more complete picture of the patient's history, schedule, medication regiment, disease, and with the benefit of a shared dedicated computer at the Network Operations Center (NOC). The local escalations may be programmed intermittently with an understanding of these other system inputs, but it is a relatively fixed state machine as opposed to the remote one that is relatively dynamic.

In a multi-compartment pillbox, each compartment may have its own visual, auditory or vibratory signal to indicate an escalation to the patient. The visual signal may in fact be based on a set of icons or displayed on an embedded display screen with particular animations that provide feedback to the patient at certain times. As a mnemonic device, a particular medication may be assigned a particular image glyph, auditory tone or vibratory pattern.

Similarly illuminated icons may indicate that the device is connected, powered, transmitting data, receiving data, needs to be refilled, refills are ready at the pharmacy, refills have been ordered, notification has been sent to the doctor, etc.

In the preferred embodiment a visual display screen may be embedded in the pillbox that can provide textual feedback to the patient. Data on this screen may instruct the patient which dose (afternoon/morning, etc.), which pill (shape, color, size) needs to be taken. The display may also provide the patient with health information or marketing communications as a function the patient's medical, behavioral or geographic profile. The display can further pose queries about the patient's state of health or other surveys. The patient may respond to multiple-choice queries by simply pressing a button or interacting with the touch sensitive screen on the pillbox. For example, the patient may be asked if they want to reorder medication or how they feel.

The pillbox preferably includes local data memory and permanent memory. The device will include a ‘store and forward’ architecture to ensure data collected on it has a physical location in which to reside if an upload network connection is not possible for some period of time.

Power Saving Feature

For the two-way version of the invention, the pillbox employs a so-called “polite” communication protocol whereby it does not talk (i.e., communicate) unless spoken to. That is, the pillbox must first listen for an incoming signal from a downstream source like the night light before broadcasting its status update. Because these devices are wireless and battery powered, they must conserve power. Ideally one pillbox (or cap) would last on the order of a year (there is seldom need to have the patients replace batteries or recharge the cap or box. A new cap can be sent when the network learns that the cap is due to expire). To accomplish this the duty cycle of communications can be low. That is, speak when spoken to unless there has been a change like a pill taking event or about to run out of battery state. If the pillbox has heard from a downstream device like the night-light in some fixed amount of time (say, e.g., 1 hour), then the cap may broadcast an update. An additional advantage of this “polite” data protocol is when the device is out of range it need not broadcast—further saving on power. Should the patient take their device onto a commercial airplane where wireless devices may not be used, without this polite protocol there would be no way for the patient to turn the broadcasting off.

A smart pill cap is a generalized version of the pillbox and this form has no buttons except the means to sense that it has been removed from the bottle.

A smart cap version provides interoperable mounting rings or bases to the cap. If needed, coupling rings are provided to enable one type of smart cap to mount to any of a variety of commercially available bottles of near similar opening diameter. This avoids having to develop custom caps for each bottle and enables patients to take this platform and use it for medications provided in vials sold by disparate retail pharmacies.

Backend

The home for the uploaded pillbox data is a Network Operations Center (NOC) (FIGS. 1, 1B). This is a virtual computational resource managed by people and automated systems that can process pillbox inputs from a plurality of patients concurrently. At the NOC the reception of the uploaded signal from a particular System Manager is lodged into a database (DB) for evaluation and signal processing. This database may include the patient's name, address, pharmacies of note, physicians of record, the contact information of a non professional caregiver the patient has identified, the prescription information (type, dose, duration, etc.), medical condition, etc.

The escalation engine accommodates a set of patient and perhaps a physician's preferences. The escalation engine determines what external feedback should be issued based on the input sensed and uploaded from the pillbox and any other network inputs. The logical decision is determined as a function, e.g., of one or more of the following: the prescribed program as it relates to the patient's pattern of adherence, physiological effects of the medication in their regimen, time of day the message is received, time of last dose, medical condition and other patient centered metrics, established medical protocols, the outcomes of past patient interventions specifically for this patient and more generally across a larger pool, the patient's stated preferences of how and whether to be contacted at certain events, the behavioral profile of the patient and their assessed readiness or attitudes towards being on the medication and several other factors. The Escalation Engine's output is a message to the NOC which acts accordingly.

The learning engine is essentially a feedback loop that parametrically adjusts to inputs with dynamic outputs to affect behavior change using a compliance platform that includes a network connected pillbox and set of services, as described herein. In some embodiments, the learning engine provides_for dynamic convergence of the most appropriate feedback to provide a particular patient based on the accumulated knowledge of what has motivated other patients demonstrating similar behavior in a similar demographic and patient (disease) profile, what has motivated this patient in the past and the stage of readiness to change behavior appropriate for the subject patient.

For example, the program may specify that a pill needs to be taken once a day between a two-hour window starting at 8 AM. If the signal has not been detected during this time frame and the local device has exhausted its escalation capabilities (cap and night-light have illuminated, queued audio and other signaling to no avail), the networked Escalation Engine can alert the NOC that it needs to issue an alert. If the dosing-state recorded in the patient's DB indicates that the pillbox has not been opened for 4 days this information can increase the urgency of the notification and escalate from an email message to a phone call, to a phone call to a nonprofessional caregiver to a phone call to the doctor's office, etc. The exact ladder of logic is initially determined in concert with the patient at the time of setup and leverages a standard of care that is validated by a physician consult. This ladder may be revised subsequently.

In some embodiments, the learning engine may adapt to deliver different messages and feedback mechanisms to different personality types in each stage of the process from non-compliance to compliance.

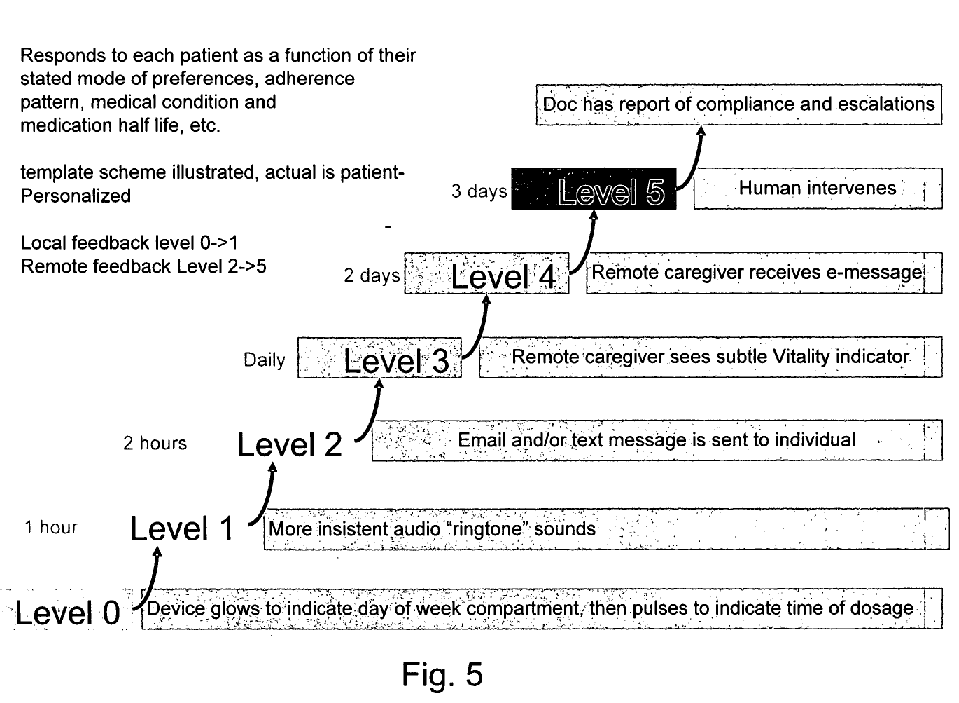

FIG. 5 depicts an exemplary escalation scheme in which the system responds to each patient as a function of their stated mode of preferences, adherence pattern, medical condition and medication half life, etc. While FIG. 5 illustrates a template scheme, it should be understood that the scheme for each actual patient is personalized. As can be seen from the example scheme in FIG. 5, feedback levels 0 and 1 are local, whereas feedback levels 2-5 are remote (and possibly also local).

In addition, the various levels of feedback may be color coded, with the colors corresponding to colors that can be displayed on the patient's devices (caps, feedback devices, containers, etc.). For example, in the scheme shown in FIG. 5, level 0 is coded green, levels 1-2 are coded yellow, levels 3-4 are coded orange, and level 5 is coded red.

In summary, in most embodiments, each patient account has a database entry. The inputs to this database include data and known state from the pillbox, a prescribed regimen and program of medications, a medically sound protocol which detail appropriate responses in certain situations and a set of user (patient) preferences on how and when to be contacted. From these inputs and prescribed actions a logical decision tree may be formed. The data representation includes as set of queries and actions.

Escalation Engine Internal Data Query and Action Examples:

The following are examples of possible escalation engine queries and related operations:
Query: Did the patient comply during the appropriate dose window?
Action: If yes, provide positive feedback.
Action: If not, escalate.
Query: Does the patient need a medication refill?
Action: If yes, determine if patient has automatic refill set up.
Action: If yes, lodge order at Pharmacy
Action: If No, send message to ask for permission to reorder at Pharmacy
Action: If No. (Does not need refill), escalate.
Data from the pillbox—dose needed, medication necessary, date of last dose, pillbox working, responses to queries on how the patient is feeling, whether they need a new prescription, etc.
Prescription regimen—course frequency, dose and number of refills prescribed
Medical Protocol—a simple data representation in a decision tree of the standard of care that a nurse or doctor would recommend based on various non-compliance and pill taking behaviors. The medically sound protocol is a logically encoded set of steps which corresponds to several factors including: when a patient on a particular medications should be contacted and the level of urgency of that contact as a function of time, the appropriate message to deliver to the patient at particular intervals, appropriate adherence, exercise or other goals that match to their regimen and progress against a particular schedule of recovery, decay, etc. A business rules engine sets these during setup phase of the service.
User Preferences—The patient enters or causes to have their communication preferences entered into the DB. For instance, during business hours please contact me via office phone number, then rollover to my cell. At night please call my home number if before 11 pm, if the alert has to do with my Diabetes please rollover to an email message, if hit has to do with my Osteoporosis medication, please leave a voice mail (vmail), etc.

More generally, in order to determine which level message should be issued the Escalation Engine has to evaluate parameters established when the Escalation Engine was programmed for the specific pillbox and patient. The inputs to that algorithm may include one or more of the following:
Past Compliance Rate for a specified period
Target Compliance for a specified period
Box owner's preference for communication mode
   Example Network Operations Center Capabilities as Directed by the Networked Escalation Engine
Level 5 Call Authorities
Level 4 Call Box Owner's Named Contact
Level 3 Call Box Owner
Level 2 Email Box Owner's Named Contact
Level 1 Email Box Owner
   Feedback Indicator

The feedback indicator preferably includes various signaling means including glowing, beeping, playing ring tones, vibrating, etc. In the simplest case the Feedback Indicator is a lamp that glows various colors. As the time approaches when a dose is necessary the lamp glows yellow, for instance. If the dose is taken the lamp can transition to green, for instance, and stay that color until the dose needs to be taken again in the next period. If the dose is missed, the lamp can transition to red (for instance). (It should be understood that in order to be effective the color key needs to be communicated to the patient.) Once the dose is taken the red will transition to green again and stay on that color until the next dose time approaches. If an error is detected by the system, the lamp may pulse yellow (battery fault) or red (box sensor error, double dosing attempted) depending on the urgency of action required. The system's ability to create one or several feedback indicators increases the awareness of a dosing requirement and may help an individual increase their compliance. As several feedback indicators can be distributed around the patient's environment (bedroom, automobile dashboard, refrigerator door, office environment, etc), the awareness of dosing can be made inescapably prominent. Given the politeness of a glowing lamp the awareness will not likely be dismissed quickly as it would for a cell phone type ringing or alarm clock.

The Feedback Indicator may additionally or alternatively be embedded in the box itself and/or may be physically distinct as described. In the preferred embodiment it is the container that houses the system manager.

System Outputs:

The Escalation Engine can call for several outputs in various and potentially overlapping and non-exclusive modes.

Reports

These are charts, graphs and tables that report the history of compliance against a program. These may be physically mailed, electronically transmitted or posted on the Web. Several different views of this information may be made available depending on the role of the person who has access to the data. The patient may receive a running summary of their compliance over the last few months with feedback customized for their particular regimen and use case. The physician may receive a summarized view on a different schedule and in a mode that accommodates their hectic and varied workflow. In the preferred embodiment this information in posted to a so-called Personal Health Record (PHR) for the patient and or integrated into the EMR (Electronic Medical Record) for the physician and other health care provider. In the latter the adherence rate may be used as a new critical dosing metric for diagnosis. The doctor can more pointedly answer the question: Is this medication ineffective, do I need to double the dose or is the patient simply non-compliant?

Coordinate Refills (reprisal)

When the pillbox senses that its contents are about to be depleted, the pillbox can issue a signal that either automatically reorders the contents or offers a signal to the pillbox owner which requests confirmation to initiate the reorder (automatic issue, conditional affirmation). This requires that the DB in the NOC contain the information necessary to transact commerce on behalf of the patient.

Alert Other People

The Feedback Indicator may be physically present and display information for the benefit of someone other than the patient, e.g., a friend or non-professional caregiver who represents the patient's interest in maintaining his or her compliance. This signal may also arrive in the form of an e-mail, phone call, facsimile, ichat, post card, etc. In order for this backup signal to be issued, the patient would have to have established a network of people they legally decide would be responsible for receiving this otherwise potentially private information, and that that person is interested in participating in this program. The patient and other individual would have to comply with regional and national legal requirements relating to medical privacy. E.g., in the U.S.A. they will have to sign the appropriate HIPAA forms.

Local Display

As noted above, the pillbox may have an image creation display that can display text or graphics embedded in it. Since the pillbox is connected to the NOC it may receive messages that pertain to the adherence, importance of maintaining compliant behavior, availability of refills, or simply feeds of news, weather, sports, etc that are of human interest to the patient. In this way, the information display that pillbox includes can become intertwined in the daily life of the patient and thereby increase the likelihood of regular dosing for the period when this is important. Well established research in behavioral psychology and adherence has shown that associating a daily task such as tooth brushing, eating or locking the door with pill taking can be an effective means of ensuring adherence. By enabling the pillbox to be a home for dynamic information that the patient has an independent desire to see (calendaring, news, weather, sports scores, etc.), we expect this will increase adherence. Furthermore, in the spirit of trying to modify the patient's behavior the presentation of this information can be held back as a reward for compliance or given ahead of a dose if the patient has habituated dosing on time.

Monetary Feedback

In some embodiments, if the patient exceeds their target adherence goals they can be offered coupons and other types of financial rewards. This incentive may motivate certain personality types to adhere and the cash flows to the patient may be subsidized by several interested parties including a pharmaceutical manufacturer, pharmacy, pharmacy benefits manager, health Insurance provider or large employer group or a third party. These funds may aggregate and be meted out via a third party as an intermediary that can account for the compliance performance and reward incentives due.

System Input option

The local display can also provide the ability to query the patient, using, e.g., a touch screen or more simply a set of buttons. This enables the NOC to lodge queries and upload the responses from the pillbox. This information may be fed into the Escalation Engine and may parametrically affect the actions taken. It also may serve a completely separate marketing channel which has no other direct benefit to the patient.

Example questions for a patient include: “Would you like to reorder medications? Are you experiencing any unpleasant side effects? Are you feeling better than yesterday? How would you rate your satisfaction with your medication? Please select A.B.C?” Those skilled in the art will immediately realize, upon reading this description, that different and/or other questions may be asked and that the questions asked may be based on the kind of inputs that the system needs.

Alternatively (or in addition), this entire transaction may be administered using an IVR system. The data provided by the patient may cause different feedback to the patient going forward.

Peripheral sensors

In some embodiments, the system manager can communicate with other sensors, displays and devices in wireless range or physically connected to it. These peripheral sensors could be, e.g., blood pressure cuffs, glucometers, spirometers, thermometers, weight scales, pedometers, etc. The pillbox may enable these devices to display their measurement data on the pillbox's embedded screen. The pillbox may remind or request that the patient take a measurement from one of the remote sensors. The sensor data may be uploaded from the peripheral device to the system manager and then out to the NOC and patient database for integration into the PHR, EMR and report cards, etc. This data may parametrically affect the escalation engine as an input and resulting outputs. All data communications are preferably encrypted for security and HIPAA compliance.

Automatic Electronic Prescription Programming

Electronic prescribing of medications is an evolving standard. Physicians are now able to prescribe a patient a medication while sitting in front of a terminal in a clinic setting. The signal is transmitted and routed and the prescription vetted against various factors such as contraindications, drug interactions, insurance (generic vs. brand) criteria, etc. The signal arrives at the preferred dispensing pharmacy and enters the pharmacists ordering management system database. When the patient arrives the prescription is in the queue for pickup. This logical flow is extended using the present system. The prescription information may be published to the pill cap/box that the patient uses. This automatic programming can be accomplished by the NOC having a secure communication with the same clearing house that routes the prescription to the pharmacist—or to the pharmacy directly. This aspect of the system will preferably use published application programming interfaces (APIs) that available to facilitate the interoperability of this data transfer. Thus, a pill box/cap can automatically program the regimen, updates to the regimen and refills needed requests to a dosing device. Furthermore this API provides business rules for informing the pharmacist what the medication compliance of the patient is. This “Medication Adherence exchange” (MAX) is an architectural component of the e-prescribing data platform. Our platform provides the ability to update the MAX, not just on a frequency which is timed to whether the prescription has been refilled or picked up at the pharmacy, but down to the minute or day or hour when the patient's dosing is detected in the home and cleared through the present inventions platform. This is important because the MAX enables pharmacists to intervene with patients directly to influence their medication compliance and the presently described framework affords that intervention/feedback loop to be tightly managed on a period which is short and enabled by the box/box sensors in the home. Pharmacist intervention may be one of the events in the escalation engine contemplated earlier.

Protocol: Behavior modification protocol

An optional component of the backend is a behavioral modification layer called change protocol. This is an information layer with at least three categories of questions and messaging to affect behavior change. This system also contemplates that individuals may be in one of a plurality of behavioral stages that are indicative of their attitude towards their medication. The immediate goal of the platform is to motivate a patient to move into the next behavioral stage, where the limiting case is full compliance. Research indicates that communicating with an individual with a message that is appropriate for their stage of readiness or attitudinal state is more effective then simply demanding action in the face of non-compliance. Behavior change takes time and managing a chronic disease requires a life-long relationship with medication regimen. So-called, dosing fatigue may set in if the patient is not in the proper state to maintain compliant behavior. The change protocol is designed to motivate patients with anti-compliant behavior through various transitional stages to the successful compliance maintenance stage using all the sensory inputs and outputs of the present platform and the learning engine detailed herein.

On Deployment

When the device is deployed, e.g., by a health professional (visiting nurse or pharmacist), information is gathered by the health professional. This includes the individual's background, medication(s) and dosing regimen. During this exchange, the health professional has the opportunity to ask key questions that characterize the patient's stage of change. For example, the patient may be asked “How prepared are you to take this medication?”; Pros: “How do you they see and value the pros of this medication?; “Do you understand the importance of adherence?”, “Does knowing this medication improves your health, even when you do not feel any different, give you comfort?”; Cons: “How do you see and value the cons of this medication?”; “Are you concerned about how much money this might cost?”; “Are you concerned about side effects this medication may have?”; “Do you understand you have a chronic disease?” The Pros and Cons are elicited to ascertain baseline decisional balance.

During a subsequent IVR session (e.g., some days/weeks/months later), the system may probe the patient's attitude and reassess their stage of readiness to change. The session could be triggered by dosing/non-dosing event or simply pseudo random outreach. The IVR session may perform an assessment of why the patient did not take their medication. E.g., did they simply forget, were they out of town, were their unpleasant side effects, did they run out medication?

During this IVR session the system has an opportunity to offer feedback on progress (e.g., “Because you've been taking this, your cholesterol has come down . . . ”; “Compared with your peers, your compliance has been quite good, you've been managing better over time . . . ”

Based on what is then known about the patient's present decisional balance or attitude stage the system may intervene with the IVR with this type of information. Ultimately the system will be able to correlate these outbound messages with particular behaviors. Did an affirmative message move a laggard forward? Did a message to their spouse cause them to become less compliant, etc? Benchmarks need be determined clinically and leveraged for each medication, disease and patient demographic target.

Report

Each patient will receive a regular (e.g., monthly) adherence report. This report may be provided in the mail or in some other manner. The report may include custom messages in order to affect their decisional balance. The report may also include incentives (e.g., pharmacy coupons, movie tickets, cash, etc.).

Use Case Scenario

The following describes a typical use case of the medication compliance platform.

(A) The customer's device UID (unique identification number), home phone number, address and name (among other data) are uploaded to the service platform via a web browser or teleconference. The pharmacist or visiting nurse or patient accomplishes this. (The UID comes off the exterior of the packaged box.)

(B) In the home the user is instructed to:
(1) Plug the night light into an eye-level wall socket near where they store their medication/caps (bathroom or kitchen).
(2) Connect their caps to their medication vials (transfer, etc.) and put the sticker on each vial which matches to each cap (hearts on hearts, diamonds on diamonds and stars on stars, etc).
(3) Plug the dongle into a phone socket near the night-light. Plug the phone into the dongle if it would otherwise displace a phone connection.

Upon plug-in, the dongle dials a phone number loaded into its memory—calling the service platform to report its status. This is effectively a “reset” action. Whenever the phone dongle is plugged in, it calls the service platform within a preset time, e.g., 60 seconds.

Once connected, the dongle transmits its UID. The dongle learns what time it is and what phone number is local (so it no longer needs to use a toll-free number to call the NOC). The dongle reports its status and then hangs up.

In preferred embodiments, the medication compliance platform is able to learn about each user to elicit that user's best adherence rate and set optimal medication-taking behavior. Given one of a set of generic machine learning algorithm, relationships between inputs and outcomes can be analyzed to determine an optimal adherence rate and an optimal medication-taking behavior.

Typical system inputs may include:
Dosing sensor data (e.g., patient took pill or not)
Dosing time of day vs. scheduled time of day (e.g., 2 minutes early, 2 hours late, 3 days late)
Other non-dosing specific metrics (e.g., patient weight, blood pressure, number of steps walked today)
Day of the week (e.g., weekday, weekend)
Dosing time of day (e.g., morning, afternoon, evening)
Stimuli which resulted in behavior change of other patients on similar regimen at similar attitudinal stages

The platform outcome based on these patient inputs is measured as an adherence rate that need be optimized for a particular patient and their demographic attributes. These outcomes can directly influence the timing, tone, frequency, and/or mode of delivery, and/or content body, fed back to the patient. With baselines established or seeded from data gathered through live interviews or pilots, hypotheses can be vetted against real world data and probabilities of outcomes attributed to whether a certain demographic profile will respond to a certain loop can be mapped to a Bayesian decision tree. This tree may be traversed (and refined based on findings) over time.

System outputs typically include one or more of the following:
Messaging content (instructional, motivational, humorous, tone of message)
Delivery modes (SMS, email, voice, print, etc)
Delivery destination (e.g., patient, care-giver, pharmacy, insurance provider)
Caregiver intervention (accountability and oversight)
Financial incentives (coupons in mail for good behavior)
Information reward (news, stock, weather information delivered with dose)

Feedback inputs may include or be based on, e.g., relationship trend history as predictor of next dose time (history: did not take yesterday, more or less likely to take today); caregiver intervention by relationship to patient (e.g., spouse called, nurse called, IVR called).

Feedback may also include or be based on collective experiences of other patients and their responses to various stimuli, especially for individuals in similar situations (e.g., other diabetes patients in the patient's psychographic and demographic cluster respond better to spousal alerts than direct phone calls, or email if the missed dose is within 2 days.)

Implementations

A preferred implementation includes:
standard 13 or 20 dram vial, pill cap with an LED that pulses when it is time for the patient to take the medicine.
a childproof cap;
a one-way wireless transmitter that can communicate up to 100 m to the feedback device.
A light sensor to detect when any ambient light is present
a lid switch which is be optically or mechanically triggered
bright tri-color LED viewable in daylight
Internal clock
Mechanism to set functionality at POS (set current time, dose time, ID#)
Battery rated for 9-12 months

In a presently preferred implementation, the light sensor activates signaling tri-color LED when any ambient light is present. The LEDs pulse red-quickly (e.g., 2 times per second) at target time and for a period of hours after if not opened. The LEDs pulse blue, slowly (e.g., once per two seconds) if lid opened and replaced for a predefined number of hours.

The preferred feedback device is in the form of a night light, e.g., as shown in FIG. 6A. In a presently preferred implementation, the feedback device is a three inch square, thin device that plugs directly into an electrical outlet. The device includes a bright backlit tricolor LED and segmented LCD with less than 200 segments. A transmitter/receiver hub communicates with pill caps and the phone dongle. In some preferred embodiments, the display is an ambient display, e.g., as made by Ambient Devices of Cambridge, Mass.

The colors match the pill cap, so, if the patient has taken her medication, it serves as a simple blue static night-light. However, if it is past the target time, the LED pulses red (e.g., twice a second). If the household contains any overdue pill caps, then the nightlight shows this.

FIGS. 6B-6F are schematic views of an exemplary night light feedback device 104′. The device 104′ includes a screen 105′ on which information can be displayed. The screen 105′ can change color, depending on the current escalation level.

The device includes memory (store and forward) to notify containers if out of range for downloads. The device preferably as a unique ID to “call” out to the platform when events occur.

The display indicates one or more of the following: whether it is connected to a dongle, the current time, the next dosage time, battery alert for caps or dongle, number of caps it is tracking, points to goal, day of week and medication history over past two weeks.

The dongle is preferably an “In-line DSL-filter-type” for standard RJ11 phone, includes a battery (9v); a status LED; a 2400 baud data modem (e.g., from Xecom 0092, CMX865A low power v.22bis Modem, Silicon Labs, ChipCom CC 1070, Linx technologies); and wireless transmitter/receiver with 100 M range.

In a presently preferred implementation, the dongle exhibits the following behavior:
Green LED indicates data connection established with “nightlight”
Green LED blinks to indicate data upload/downloading
Red LED blinks to indicate error
V92 or v22 protocol (line-drops on inbound/outbound contention)

Thus is described a medication compliance platform. Variations of the above-described embodiments are within the scope of the invention.

In summary, in some preferred embodiments, the system consists of a medication container (box) that senses when it is opened and closed and either infers by the opening/closing action that something was removed or measures that something was removed and then provides feedback to the user based on their alignment of openings/closings against a prescribed regimen. The container may be a dispenser that dispenses prescribed or fixed amounts of medication.

Further, in preferred embodiments, the system attempts to motivate adherence to an opening/closing regimen with a set of communications (interventions) that trigger based, e.g., on a set of rules (or protocols) established to educate, reward, report, remind and/or account for the user's behavior.

As used herein, the term “medication” refers to any kind of medicine, prescription or otherwise. Further, the term “medication” includes medicine in any form, including, without limitation pills, salves, creams, ointments, capsules, injectable medications, drops, vitamins and suppositories.

The programmed schedule is typically derived from a physician's medication prescription and disease or attitude-specific protocol. The box may be networked and remote interventions that sense non-compliance against the schedule can cause external signals to be generated to prompt the patient. In addition, the system may account for positive compliance causing external signals that further motivate and reward (e.g., financially, or by providing held back information of interest) the patient's behavior. Feedback loops between the box and remote displays may be used to create awareness in the home, office, automobile or in other environments the patient inhabits. These feedback loops can indicate the patient's compliance while they are not interacting with the box and create signals that are, e.g., cautionary or congratulatory. Furthermore the communication loops can feedback directly to the patient via various means (e.g., phone, SMS, email, change in light, audio queue, etc.) and/or indirectly to another person (e.g., remote care giver or friend/family member, physician, pharmacist, nurse) who can reach out to the patient directly. The system attempts to deliver the right message to the right person at the right time in the right mode in a way which optimizes their medication adherence behavior.

The system bundles capabilities and enable the platform and patient's interactions with it to govern a set of feedback loops. Coupled with one of several generic machine-learning algorithms, over time, the platform causes a unique mix of signals to be tuned to each particular patient's behavior in a way that optimizes outcomes (medication adherence) given patient's then present adherence rate and attitude stage.

The platform can generate both local reminders (on the devices in the patient's home) and remote interventions which are generated asynchronously. After an initial setup, the two subsystems (local and remote) need not communicate with each other again in order to trigger feedback. With synchronicity between the two components the ability to affect patient adherence improves. One benefit of asynchronous communication is that the patient need not be in the home (in range) to receive the benefits of the platform.

An implementation of the described system/platform for medication compliance overcomes some or all of the reasons for non-compliance, as summarized here:
1) No doctor-patient accountability:

One well-known behavioral tenet is the so-called Sentinel Effect that describes that people will act differently if they know they are being watched. If a patient knows that their doctor knows (or might know) if they are taking their medication, then the patient is more likely to comply. Using the present system, the hint of patient accountability is created because the patient knows that the container in which their pills are stored will provide a report to their physician, nurse, loved one or remote caregiver on some schedule. It is not so important that the remote person takes action, it is just providing for this accountability that is of value.

The platform may provide measurable feedback to the patient in the form of a periodic report and regular feedback (e.g., daily or hourly) in the home with local visual and audio queues.
2) Medication is too expensive:

The system may provide financial incentives for compliance.
3) No Social Support:

Using the disclosed system enables patient to share medication adherence with others, e.g., loved ones and caregivers in the patient's circle of care. Using their existing relationships as points of influence in the motivation and recognition of compliance efforts and dosing behaviors improves adherence. The system enables the inexpensive scaleable management of patient's social network.
4) Patient's Complain that Refills are a Hassle

Delaying or forgetting to refill a (soon to be) depleted script is a common drop off point on compliance. The platform has the capability to communicate with the prescribing pharmacy that it is time for a refill. The platform preferably keeps a dose count of the amount of medication used (e.g., drops, pills, etc.) and makes the assumption that upon each opening/closing of the container, medication is removed at the prescribed rate. When the regimen is approaching a “refill needed” state (e.g., number of pills falls below threshold), the platform communicates to the pharmacy that a script is warranted. If cleared through billing, prescription, drug interactions, etc. the pharmacy can refill the script. It can also communicate back to the patient or with the device (e.g., pill box or night light or by phone or e-mail or the like) in the home that the refill is ready for pickup. Further, in some embodiments, pharmacies can communicate with the prescribing physician (e.g., on a monthly report or instantly) that the refills have been picked up. The system thus enables a physician to monitor script pickup, thereby providing another form of doctor-patient accountability.
5) Some patients do not think they need the medication or experience unpleasant side effects:

An embodiment of the platform enables textual messages to be communicated to the medication container for display on an embedded screen or via outbound messaging (e.g., email, SMS, IVR, and/or phone). In this mode a patient who is non-compliant may be educated on the important benefits of their medication and those patients experiencing unpleasant side effects can have expectations set as to the side-effects' duration, intensity and can more objectively evaluate the tradeoffs of elective non-compliance in the face of these side effects.
6) Patients do not know how to use the medication:

Patients may also receive instructive and informative information as to how to use their medication, when to take it, what the medication does or why they should comply.
7) Patients forget to take their medication:

This is the primary focus of past attempts at lifting medication compliance rates. Such approaches tried, e.g., to combine a pillbox with an alarm clock. Programming of dosing reminder alarms may be either explicitly prescribed or adaptively determined. In the explicit case an individual may use an (Interactive Voice Response) IVR system or web page to communicate the preferred dose alarm times. In the adaptive case the sensor cap or box is used and this use sets a time-averaged alarm going forward. A patient's clock is clear on day zero. The patient uses the device at a particular time or set of times throughout the day. This use sets the alarm for the next use 24 hours later. That is, if a patient uses the pillbox at 11:20 am, the device will alarm at 11:20 am the following day. If however the patient uses the device at 10:50 the following day then on the third day the alarm will trigger at 11:05, etc. A multiple day dosed pill will have the same behavior with each dose triggering a 24-hour alarm (modulo time average) later.

Unlike the prior systems, the present framework and related devices offer more than simple reminders. Escalation by the present system is not limited to reminding another party when the patient has failed to take her medicine. Further, unlike prior systems, the present framework provides for continuous education and the ability to include a discrete glanceable ambient device.

The present system is not only about reminding, but motivation, rewarding, informing and reducing the pain points of medication cost, the hassle of refills and lack of timely education. Research indicates that forgetfulness accounts for less than a quarter of the reasons why people do not adhere to medication regimens. The present system addresses multiple factors simultaneously. The cost reduction can be partially addressed if a network view of the patient's compliance could be reliably captured and reported to those in whose financial interest it is for the patient to comply. A rebate for compliance is not unreasonable. A medication container that knows how much medication is inside and when it is due to deplete and which can be connected to a network can coordinate refill signals with a pharmacy. Once this communication path is in place it can receive dosing regimen information from the pharmacy as well, should the medication change. In addition, patients who are on medications often are educated about the benefits and expected side effects when they are first prescribed the medication and not re-educated later. The present system allows for continuous education through its various communication channels and this has the potential to increase the understanding as to why the patient is on the medication and when and what to expect in terms of side effects, if any.

Unlike prior systems, the present system can provide local direct feedback to the patient and can provide escalating reminders in the local range of the pill cap or even on the pill cap itself. In the present system, feedback is not dependent on connectivity to the network. The system provides for analysis of the historical trend of the patient's compliance to govern the set of messages transmitted to the patient or remote caregivers.

While the invention has been described in the context of compliance, those skilled in the art will understand, upon reading this description, that no distinction is made between medication compliance and adherence, in a strict sense, the later being derived from the former.

Although aspects of this invention have been described with reference to a particular system, the present invention operates on any computer system and can be implemented in software, hardware or any combination thereof. When implemented fully or partially in software, the invention can reside, permanently or temporarily, on any memory or storage medium, including but not limited to a RAM, a ROM, a disk, an ASIC, a PROM and the like.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method of aiding medication compliance, the method comprising,
for a patient, for a particular medication for which the patient has a specific compliance schedule,
providing a patient-specific feedback scheme for the particular medication;
monitoring the patient's compliance with the specific compliance schedule;
providing feedback according to the feedback scheme and responsive to said monitoring; and
modifying the feedback scheme based, at least in part, on the patient's compliance with the specific compliance schedule and the patient's response to provided feedback.

2. A method as in claim 1 wherein the feedback scheme includes one or more of:
providing information to the patient; and
providing information to others.

3. A method as in claim 2 wherein the information provided to the patient includes one or more of:
alert information;
information relating to the medication;
information relating to the need for the medication;
information relating to consequences of non-compliance with the schedule;

4. A method as in claim 2 wherein the information provided to the patient is provided by one or more of: voice mail; e-mail; an SMS; a telephone call and a facsimile.

5. A method as in claim 1 further comprising:
obtaining an initial baseline measure of the patient's expected compliance with the compliance schedule; and, at a later time,
obtaining at least one other measure of the patient's expected compliance, based, at least in part, on the patient's compliance history.

6. A method as in claim 2 wherein the information provided to the patient is provided on a container for the particular medication.

7. A method as in claim 3 wherein the information provided to the patient is provided on a device operatively connected to a container for the particular medication.

8. A method as in claim 6 wherein the information is provided on a cap of the container.

9. A method as in claim 7 wherein the device is wirelessly connected to the container.

10. A method as in claim 9 wherein the device is contained in a nightlight.

11. A method as in claim 1 further comprising:
repeating the step of modifying the feedback scheme at least once.

12. A method as in claim 1 wherein the feedback scheme is modified based, at least in part, on collective experiences of other patients and their responses to various stimuli.

13. A method as in claim 2 wherein the step of providing information to others includes one or more of:
providing information to a designated medical practitioner;
providing information to a designated caregiver; and
providing prescription refill information to a pharmacy.

14. A method of aiding medication compliance, the method comprising,
for a patient, for each medication of a plurality of medications, wherein the patient has a specific compliance schedule for each said medication,
providing a feedback scheme for the medication;
repeatedly monitoring the patient's compliance with the specific compliance schedule for that medication;
providing feedback according to the feedback scheme and in response to said monitoring; and
modifying the feedback scheme based, at least in part, on the patient's compliance with the specific compliance schedule for that medication and the patient's response to feedback from the feedback scheme; and
repeating the step of modifying based, at least in part, on the patient's compliance with the then-current feedback scheme.

15. A medication compliance system, wherein a patient has a patient-specific and medication-specific compliance schedule, comprising:
a mechanism constructed and adapted to provide the patient with a patient-specific and medication-specific feedback scheme;
a monitoring mechanism constructed and adapted to monitor the patient's compliance with that patient's patient-specific and medication-specific compliance schedule;
a feedback mechanism constructed and adapted to provide feedback to the patient, based, at least in part, on that patient's monitored compliance with the feedback scheme;
a modifying mechanism constructed and adapted to modify the feedback scheme based, at least in part, on the patient's compliance with the compliance schedule and the patient's measured compliance in response to feedback from the feedback mechanism.

16. A system as in claim 15 wherein the modifying mechanism is further constructed and adapted to modify the feedback scheme, based, at least in part, on collective experiences of other patients and their responses to various stimuli.

17. A device, operable in a medication compliance system, wherein a patient has a patient-specific and medication-specific compliance schedule, the device comprising:
an ambient display constructed and adapted to alert a patient that a dose has been missed by changing the color of the display.

18. A device as in claim 17 wherein the display is in the form of a nightlight.

19. A device as in claim 17 further comprising:
a mechanism constructed and adapted to wirelessly connect the device to a source of alert information.

20. A cap for a medicine container, the cap comprising:
a multi-color light-emitting diode.
